(19) United States
(12) Patent Application Publication
(10) Pub. No.: US 2018/0000022 A1
(43) Pub. Date: Jan. 4, 2018

(54) Light traps and panels for light traps

(71) Applicant: Stanley Vincent Kulkaski, Warren, NJ (US)

(72) Inventor: Stanley Vincent Kulkaski, Warren, NJ (US)

(21) Appl. No.: 15/530,687

(22) Filed: May 20, 2016

(51) Int. Cl. A01G 9/24; A01G 9/22

(52) U.S. Cl. CPC A01G 9/24; A01G 9/22

(57) ABSTRACT

A guard assembly for use on a guy-wire of the type having an end terminating in a loop, or other style, comprises an elongated tubular member of a relatively rigid plastic having a hollow interior throughout its length. The tubular member has an included single hollow tubular member, accessible though a slot, extending longitudinally thereof between opposite ends to allow the tubular member to be in surrounding relationship by being moved laterally thereover with the guy-wire hollow interior through the split. The guard can be snapped onto the wire using pressure and secured into place with a u-bolt or similar device.

### FIELD

The current disclosure relates generally to horticulture houses, and more particularly to light traps for horticulture houses, the traps having increased light reduction.

### BACKGROUND

Light traps, e.g. those for horticulture, are known in the art in general functional terms, light traps block natural light, while allowing air to flow through. As such, they can be used in combination with artificial lights to create an artificial diurnal cycle inside a structure. In horticulture houses, a diurnal cycle may be important for a variety of reasons. Some horticulturists may use the cycle to control air and soil temperatures.

As noted, light traps are constructed to allow airflow through the trap. The flow of air through the trap and into the horticulture house is important for a variety of reasons including air exchange and temperature control. For example, air flow decreases humidity therefore minimizing soil moisture.

Applicant believes that existing light trap require users to compromise either resistance to light transmission or resistance to airflow. FIG. 1, for example, illustrates a known light trap 2, which provides satisfactory resistance to light transmission at the price of increased resistance to airflow, tight trap 2 includes a plurality of panels 4, each defining a plurality of right angles, 4a reduce light transmission from an outside 6a to an inside 6b, and create a resistance to airflow 10.

It is to at least one or more of these additional problems that the current disclosure is directed.

### SUMMARY

By way of brief summary, the current disclosure is directed to light traps, e.g. light traps for horticulture houses, having light deflective patterns (LDPs) positioned on panels of the trap. The current disclosure is also directed to panel for light traps, wherein the panels include LDPs Using LDPs, applicant has discovered that resistance to light transmission can be increased.

The above summary was intended to summarize certain examples of the present disclosure. Systems and panels will be set forth in more detail, along with examples demonstrating efficiency, in the figures and detailed description below.

### BRIEF DESCRIPTION OF THE FIGURES

FIG. 1 shows a cut-away view of a known light trap.

FIG. 2 shows a front view of a light trap positioned within a structure.

FIG. 3 shows one example of a cut-away view of a light trap panel as disclosed herein.

FIG. 4 shows a perspective view of one example of a panel, for a tight trap as disclose herein.

FIGS. 5 and 6 show manufacturing specifications for an example as disclosed herein.

### DETAILED DESCRIPTION OF VARIOUS EMBODIMENT EXAMPLES

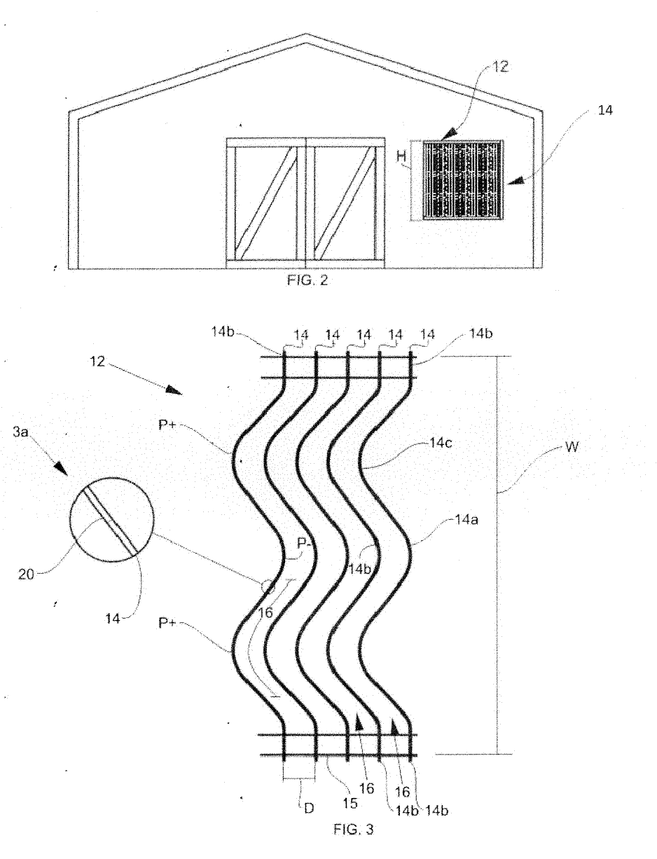

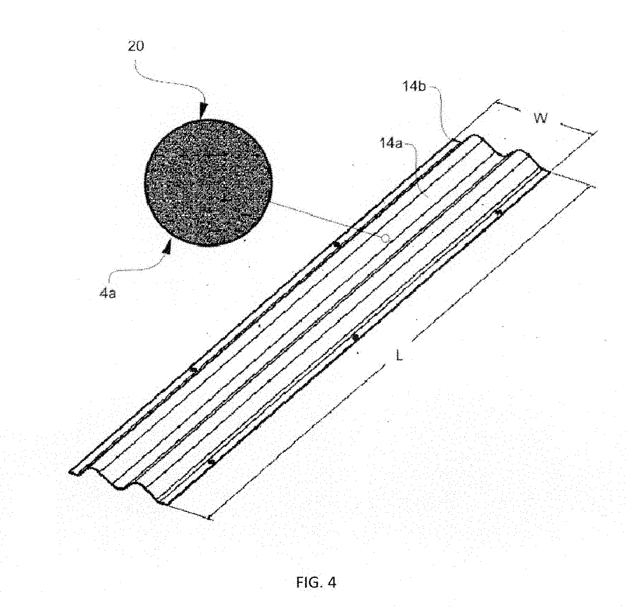

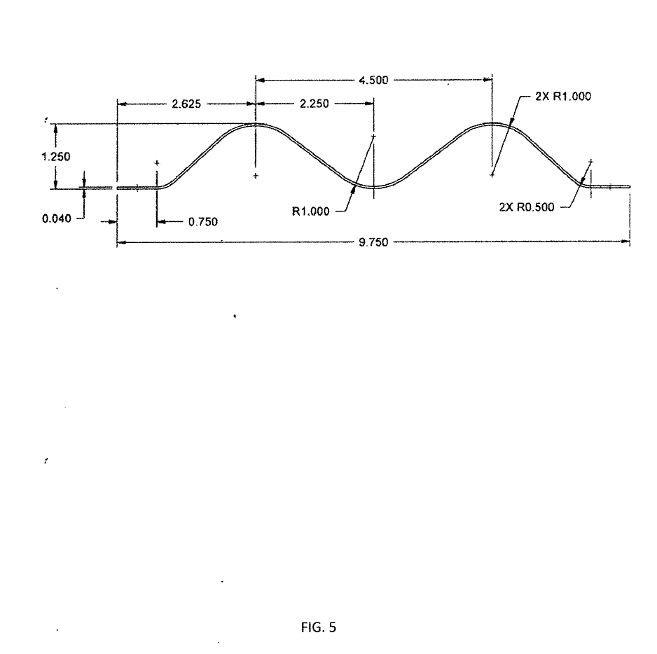

FIG. 2 shows a front view of light trap, 12 which is one example of a tight trap as disclose herein, positioned in a structure, e.g., horticulture house. FIG. 3 shows a cut-away view of light trap 12 including panels 14 and housing 15. FIG. 4 shows an isolated panel 14 which may be considered one of the pluralities of panels of trap 12.

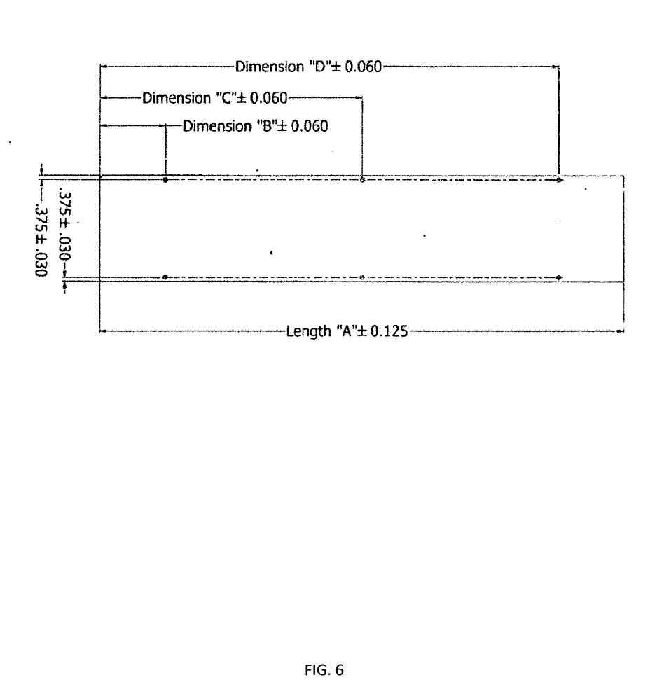

FIGS. 5 and 8 show various shows various manufacturing specifications and views of a panel example, which may be considered similar to panel 14. Similar reference numbers will be used to refer similar parts shown in the various figures. It should be clear however from the description below that trap 12 is representative of a variety of fight trap examples, variations of which are described below.

In this example, trap 12 includes a plurality of panels 12. Each panel 14 is described as having a width W and a length L. Panels 14 define a waveform 12a for at least s portion. As seen, waveform portions 14a travel in the width direction of the panel. Waveform portions include a plurality of peaks (P), including at least one positive peak and at feast one negative peak. Positive and negative are used indicate relative direction. In this example, each panel 14 may be considered to have two positive peaks (P+) and one negative peak (P−) for reference only.

Panels may be completely waveform, or may have other non-waveform portions, e.g., interface edges 14b, may be straight for example. Straight portions, e.g., 14b may be used for mounting purposes, etc, Non-waveform portions may also be located in other locations between the edges. Trap examples including a plurality of panels defining a waveform for at least a portion in addition to at least one panel not defining a waveform, are still considered to fail within the scope of the disclosure. The distance D between panels can vary from trap to trap, based on, for example, peak-to-peak amplitude, with greater amplitudes allowing for D.

A variety of different waveforms may be used for traps disclosed herein. Referring to FIG. 5, for example, peak-to-peak amplitude 22 can vary. For example, peak-to-peak amplitude may be in the range of about 0.5 to about 3 inches, in the range of about 0.5 to about 2 inches, arid in the range of about 0.8 to about 1.4 inches, in the example shown, peak-to-peak amplitude is about 1.2 inches. Somewhat similarly, wavelength 24 may also vary. For example wavelength 24 may be in the range of about to about 8 inches, in the range of about 3 to about 8 inches, and in the range of about 3 to about 5 inches. In the example shown, wavelength 24 is about 4.5 inches. Further, the shapes of the waves themselves may vary in some examples. In the example shown, the wave shape is sinusoidal, but other examples may include other shapes, e.g., saw tooth, etc.

Referring back, to primarily FIG, 3, in terms of trap construction, panels 14 are positioned and are spaced a distance D apart such as their wave form portions define a plurality of non-linear air-passages 16 for allowing an airflow (AF) in or out of fee horticulture house at a velocity (V). As used herein, non-linear is intended to mean that, for at least one air-passage, a straight line cannot be drawn from and light trap entrance to a light trap exit. The distance D between panels can vary from trap to trap, based on, for example, peak-to-peak amplitude, with greater amplitudes allowing for greater D. In some examples, D may be in the range of about 0.5 to about 2 inches from the center of one panel to the center of an adjacent panel. In many examples, D will be about 0.75 inches from the center of one panel to the center of the next panel. The resultant air-passages have a resistance to airflow (RAF) and light reduction factor (LRF). In some examples, D may be correlated with a desired LRF, for example, D may be greater if a lower LRF is acceptable. Spacing between panels may be achieved, for example, by housing, e.g., housing 15, having recesses, flanges, slots, etc. for securing an interface edge of the panel in some examples, panels may be secured directly to the structure, e.g., without a housing, by individually fastening a portion of the panel to the structure. Such examples may also be considered light traps, as used herein.

Panels 14, e.g., waveform portions of panels, have a plurality of light deflecting patterns (LDP's) 20 as illustrated in the cross-sectional enlargement 3a, surface enlargement 4a and detail A of FIG. 5. LDPs are constructed to maintain a comparable RAF relative to a control without LDPs. LDPs shape, height, positioning, concentration and orientation may vary from example to example.

Regarding the shape of the LDW, it may vary. In some examples, the LDPs may be rectangular shaped, e.g. as illustrated in FIG. 3. In other examples, LDPs may be semicircular, e.g. as illustrated in FIG. 5, detail A. Still in other examples, LDPs may have other shapes, e.g., triangular, LDP's may also include a combination of shapes within a panel.

Regarding height, in some examples, LDPs have a pattern density in the range of about 95% to about 100%.

Regarding positioning, in some samples, LDPs will be positioned on the entire waveform portion and on the top surface of the waveform. In other examples, LDPs will be positioned on lesser portions of the waveform. For example, some waveform portions include LDPs positioned on at least one of: at least 25% of a wavelength; at least 50% of a wavelength; at least 75% of a wave length; and about 100% of the wavelength. Further, in many examples, panels will be position such that the LDPs of one panel overlap, at least partially, with the LDPs of an adjacent panel. For example in FIG. 2, at least one panel portion 14c contains LDPs and at least adjacent panel portion 14b contains LRW, which may overlap with the LDPs in portion 14c. Other samples may include more or less overlap.

Regarding orientation, LDPs will typically be oriented on the top surface of the waveform. For example, LDPs 20 in cross-sectional enlargement 3a and LDPs 20 in surface enlargement 4a are shown on the top surface of the waveform.

Regarding concentration, LDP's may be positioned in a variety of concentrations of the hair cell pattern. For example, LDPs may be positioned at a concentration chosen from at least one from about 95% to about 100% of the surface area of the panel.

In terms of construction, LDPs may be created in a variety of ways. For example, LDPs may be defined by the panel itself, e.g., by extrusion. Somewhat similarly, LDPs may be formed by vacuum forming plastic sheets.

Using light traps as disclosed herein, LRF may be improved. For example, LRF may be increased by a factor chosen from various density of pattern. Other examples may provide other improvements.

In addition to significant improvements in LRF, many examples will not significantly increase RAF. For example, RLF may be increased without increasing RAF by greater than 0.25 inches H2O, or greater than 0.010 inches H2O, at a velocity of 600 fpm.

Further some panels may have an antistatic component, e.g. an additive in the panel itself or a coating applied to the panel, to inhibit particles from bonding to panels. Applicant believes that antistatic component will provide for improved RAF. Examples including antistatic components include traps having LDPs as well as panels without LDPs.

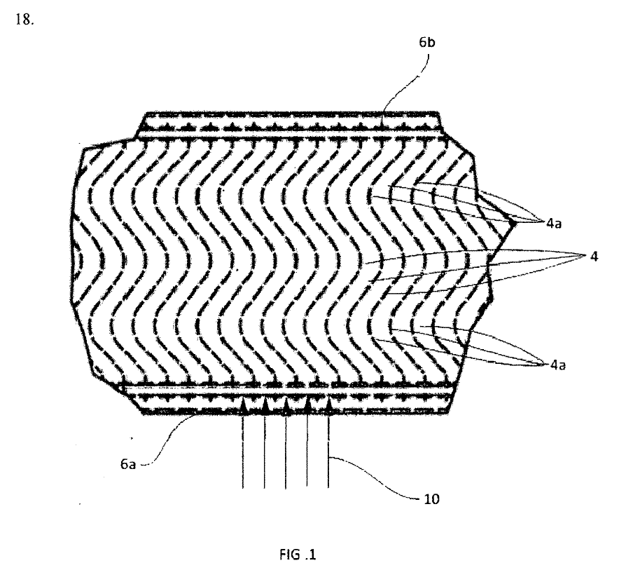

Using the teachings contained herein, any of a variety of benefits may be achieved. For example, LRF may be significantly increased without sacrificing RAF further, existing traps can be replaced, e.g. similar to the trap in FIG. 1, to provide similar levels of LRF and provide a significant energy savings. Applicant estimates, for example, that the current disclosure can be use to provide 30% savings in energy without significant sacrifice to LRF in some examples.

The following experimental data is for purposes of illustrating efficacy, not limitation.

### EXPERIMENTS

Experimental Trap A (Etrap a) reference in the experiments below refers to a trap having the specifications illustrated in FIGS, 5 and 6 and their accompanying description.

Control Trap referenced in Experiments below refers to a trap having specifications similar to Etrap with the exceptions of the LDPs, which are lacking in the control.

### Experiment 1

### Resistance to Light Transmission

The traps were mounted in a 48″×48″ opening in a light blocking wall. Four 1500 W halogen lamps were place on one side of the trap so simulate direct sunlight. Light measurements were taken outside the trap and inside the trap using an international light IL-1710 light meter. The light reduction factor (LRF) was calculated by dividing the outside light intensity by the inside light density. A higher LRF indicates a greater resistance to light transmission.

### Control Panel Results

1. Light Intentsity Outside (fc)

Readings: 5460, 5000, 6350, 6440, 5660, 6110

Mean: 5837

2. Light Intensity Inside (fc)

Readings: 0.00055, 0.00055, 0.00057, 0.00075, 0.00038, 0.00064

Mean: 0.000563

3. Light Reduction Factor (LRF) (Outside/inside)=10,400,000

### ETrapA Results

1. Light Intensity Outside (fc)

Readings: 5290, 6210, 5530, 5450, 5630, 4380

Mean: 5415

2. Light intensity Inside (fc;

Readings: 0.00022, 0.00031, 0.0002, 0.0003, 0.0035, 0 . . . 23

Mean: 0.000268

3. Light Reduction Factor (LRF) (Outside/Inside)=20, 180, 000

As seen, the invention example provides greater than 2.5× improvements in light reduction relative to the control.

### Experiment 2

### Resistance to Airflow

Traps were mounted in a 48″×48″ opening in a BESS Lab airflow measurement chamber. Static pressure was measured in inches of water (“in water”) at velocities ranging from approximately 200 feet per minute (fpm) to approximately 100 fpm.

At a given face velocity, a lower static pressure indicates less airflow resistance.

| Control Trap | | | ETRAP A | | |
|---|---|---|---|---|---|
| Static | | | Static | | |
| Pressure | Airflow | Velocity | Pressure | Airflow | Velocity |
| (in. H2O) | (cfm) | (fpm) | (in. H2O) | (cfm) | (fpm) |
| 0.010 | 3219 | 201 | 0.010 | 2510 | 157 |
| 0.015 | 3990 | 249 | 0.015 | 3411 | 213 |
| 0.020 | 4469 | 279 | 0.020 | 3878 | 242 |
| 0.040 | 6353 | 397 | 0.040 | 5761 | 360 |
| 0.050 | 7148 | 447 | 0.050 | 6511 | 407 |
| 0.080 | 9179 | 574 | 0.080 | 8244 | 515 |
| 0.100 | 10388 | 649 | 0.100 | 9411 | 588 |
| 0.125 | 11498 | 719 | 0.125 | 10372 | 648 |
| 0.150 | 12707 | 794 | 0.150 | 11601 | 725 |
| 0.200 | 14747 | 922 | 0.200 | 13507 | 844 |
| 0.250 | 16440 | 1028 | 0.250 | 15294 | 956 |
| 0.300 | 18127 | 1133 | 0.300 | 16819 | 1051 |

As seen, the invention examples provide virtually identical resistance to airflows patterns. Numerous characteristics and advantages have been set forth in the foregoing description, together with the details of structure and function. The disclosure, however, is illustrative only, and changes may be made m detail, especially in matters of shape, size, and arrangements of parts, within the principle of the invention, to the full extend indicated by the broad general meaning of the terms in which the general structural examples below are expressed.

Notwithstanding that the numerical ranges and parameters setting forth the broad scope of the disclosure are approximations, the numerical values set forth in the specific examples are reported as precisely as possible. Any numerical value, however, inherently contains errors resulting from the standard deviation found in their respective testing measurements. Moreover, all ranges disclosed herein, are to be understood to encompass any and ail sub ranges subsumed therein, and every number between the endpoints. For example, a stated range of “1 to 10” should be considered to include any and all sub ranges beginning with a minimum value of 1 or more, e.g. 1 to 6.1, and ending with a maximum value of 10 or less, e g. 5.5 to 10, as well as all ranges beginning and ending within the endpoints, e.g. 2 to 9, 3 to 8, 3 to 9, 4 to 7, and finally to each number 1, 2, 3, 4, 5, 6, 7, 8, 9 and 10 contained within the range. Additionally, any reference referred to as being “incorporated herein” is to be understood as being incorporated in its entirety.

It is further noted that, as used in this specification, the singular forms “a”, “an”, and “the” include the plural referent.

What is claimed is:

1. A light trap panel for a horticulture house, the trap comprising: a plurality of panels having a length and width, wherein each of the panels defines a waveform for at least a portion, the waveform extending in the width direction of the panel, where; in the plurality of panels are spaced a distance D apart, such as their waveform portions define a plurality of non-linear air passages for allowing airflow (AF) into or out of the horticulture house at a velocity (V), wherein the air passages have a resistance to airflow (RAF) and a light reduction factor (LRF), wherein each of the waveform portions has a plurality of light deflecting walls (LDPs) orientated norvparallei to the direction of the waveform, and wherein the LDPs protrude outward from the panel and each LDW has at least two surface areas substantially perpendicular to the panel adapted to block light from advancing beyond said LDW.

2. The trap of claim 1, wherein the waveform portions include, at least three peaks with at least one of the three peaks being a negative peak.

3. The trap of claim 1, wherein the waveform portions include the waves having peak-to-peak amplitude chosen from at least one of about 0.5 to about 3 inches, about 0.5 to about 2 inches and about 0.8 to about 1.4 inches.

4. The trap of claim 1, wherein the waveform portions have a distance between two successive peaks chose form at least one of about 2 to about 8 inches, about to about 6 inches and about 4 to about 5 inches.

5. The trap of claim 4, wherein the waveform portions include LDPs positioned on at least one of: at least 25% of a wavelength, at least 50% of a wavelength, at least 75% of a wavelength and at least 100% of a wavelength.

6. The trap of claim 5, wherein the LDPs are positioned at concentration chosen from at least one of about 5% to 50% of the surface area.

7. The trap of claim 1, wherein, the waveform portions are sinusoidal.

8. The trap of claim 1, wherein the LDPs have a pattern concentration from at least one of about 95% to about 100%.

9. The trap of claim 1, wherein the LDPs of one panel overlap, at least partially over, with the LDPs of an adjacent panel.

10. The trap of claim 1, wherein RAF is chosen from at least one of 100 to 20,000 fpm, 3,000 to 25,000 cfm and 3,000 to 20,000 cfm.

11. The trap of claim 1, wherein V is chosen from at least one of 200 to 20,000 fpm, 300 to 15,000 fpm and 400 to 12,000 fpm.

12. The trap of claim 1, wherein at a velocity of 600 fpm, me LDPs will increase LRF without increasing RAF by greater than 0.25 inches of H2O.

13. The trap of claim 12, wherein, at 600 fpm, the LDPs increase LRF, without increasing RAF by greater than 0.10 inches H2O.

14. A light trap for a horticulture house, the trap comprising a plurality of panels having a length and width wherein each of the panels defines a waveform for at least a portion, wherein the waveform of each plurality of panel travels in the width direction of the panel:, includes a peafc-to-peak amplitude in the range of about 0.5 to about three inches, including a wavelength haying a distance between successive peaks in the range of about 2 to about 8 inches, and includes a plurality of light deflective walls (LDPs) orientated non-parallel to the direction of the waveform, wherein the LDPs protrude outward from the panel and each LDW has at least two surfaces area substantially perpendicular to the panel; and wherein the plurality of the panels are spaced at a distance D apart such that their waveform portions define a plurality of non-linear air passages for allowing an airflow (AF) into or out of the horticulture house at a velocity (V), the plurality of the passages having a resistance to air flow (RAF) and a light reduction factor (LRF).

15. The trap claim of 14, wherein the plurality of LDPs has a hair cell pattern concentration of about 95% to about 100% on the fop surface of the waveform, and increase LRF by a factor of at least 1.2×.

16. In a horticulture house, a panel for positioning within a light trap having a height and a width, the panel comprising: an interface edge for connecting to at least one of a housing or a building; waveform defined by at least a portion of the panel, wherein the waveform travels in the width direction of the panel, includes a peak-to-peak amplitude in the range of about 0.5 inches to about three inches, includes a plurality of tight deflecting wails (LDPs) orientated non-parallel to the direction of the waveform wherein the LDPs protrude outward from the panel and each LDE has at least two surfaces area substantially perpendicular to the panel: and wherein the panel may be spaced a distance D apart from a second panel to define non-linear air passages for allowing an airflow (AF) into or out of a building at velocity (V), the passage having a resistance to airflow (RAF) and a light reduction factor (LRF).

17. The panels of claim 16, wherein the plurality of LDPs has b pattern concentration of about 95% to 100% for at least one wavelength, are orientated on the top surface of the waveform, and increase LRF of the passage by a factor of at least 1.2×.

18. The panel of claim 17, wherein the waveform includes at least two positive peaks and at feast one negative peak.
